(19) United States
(12) Patent Application Publication
(10) Pub. No.: US 2012/0072262 A1
(43) Pub. Date: Mar. 22, 2012

(54) Measurement System Assessment Tool

(75) Inventors: Arthur H. Crapsey, III, Manchester, MO (US); Katherine R. Runkle, Hoagland, IN (US); Edward Peter Kearns, III, San Diego, CA (US); Martin William Ericson, JR., Concord, NC (US); Holliday Gaston Shaw, Cornelius, NC (US); Thomas R. Williams, Mansfield, TX (US)

(73) Assignee: Bank of America Corporation, Charlotte, NC (US)

(21) Appl. No.: 12/885,924

(22) Filed: Sep. 20, 2010

(51) Int. Cl. G06F 17/30

(52) U.S. Cl. 705/7.32

(57) ABSTRACT

A measurement system assessment tool is disclosed. In particular embodiments, a method includes communicating a plurality of questions associated with a plurality of dimensions of a measurement system. The method further includes receiving a response to each of the plurality of questions, each of the plurality of responses associated with one of a plurality of dimensions of the measurement system. The method further includes determining, for each of the responses, a numerical value associated with the response. The method also includes, for each of the plurality of dimensions, selecting a subset of the plurality questions, each of the questions in the subset associated with the same respective dimension of the measurement system. The method further includes calculating, for each of the plurality of dimensions, an average score, wherein each average score comprises an average of the numerical values associated with the questions in the subset.

### TECHNICAL FIELD OF THE INVENTION

The invention relates generally to information analysis, and more particularly to a measurement system assessment tool.

### BACKGROUND OF THE INVENTION

In analyzing business processes, six-sigma represents a process that is generating correct results 99.99996 percent of the time. Six-sigma also represents a mathematical statement that an organization is doing the things that allow it to gather information regarding the process, and verify that it is executing the process at an expected level. Six-sigma may be applied to transactional or production processes in business.

### SUMMARY OF THE INVENTION

In accordance with teachings of the present disclosure, systems and methods for a measurement system analysis tool are disclosed.

In one embodiment a method includes communicating a plurality of questions associated with a plurality of dimensions of a measurement system. The method also includes receiving a response to each of the plurality of questions, each of the plurality of responses associated with one of a plurality of dimensions of the measurement system. The method further includes determining, for each of the responses, a numerical value associated with the response. The method also includes, for each of the plurality of dimensions, selecting a subset of the plurality questions, each of the questions in the subset associated with the same respective dimension of the measurement system. The method further includes calculating, for each of the plurality of dimensions, an average score, wherein each average score comprises an average of the numerical values associated with the questions in the subset.

In another embodiment, a system includes a processor operable to communicate a plurality of questions associated with a plurality of dimensions of a measurement system. The processor is further operable to receive a response to each of the plurality of questions, each of the plurality of responses associated with one of a plurality of dimensions of a measurement system. The processor is further operable to determine, for each of the responses, a numerical value associated with the response. The processor is also operable to, for each of the plurality of dimensions, select a subset of the plurality questions, each of the questions in the subset associated with the same respective dimension of the measurement system. The processor is also operable to calculate, for each of the plurality of dimensions, an average score, wherein each average score comprises an average of the numerical values associated with the questions in the subset. The system also includes a memory coupled to the processor operable to store each of the numerical values, the average scores, and the responses.

In yet another embodiment, a non-transitory computer readable medium is encoded with logic, and the logic is operable, when executed on a processor to communicate a plurality of questions associated with a plurality of dimensions of a measurement system. The logic is also operable to receive a response to each of the plurality of questions, each of the plurality of responses associated with one of a plurality of dimensions of the measurement system. The logic is also operable to determine, for each of the responses, a numerical value associated with the response. The logic is further operable to, for each of the plurality of dimensions, select a subset of the plurality questions, each of the questions in the subset associated with the same respective dimension of the measurement system. The logic is also operable to calculate, for each of the plurality of dimensions, an average score, wherein each average score comprises an average of the numerical values associated with the questions in the subset.

Technical advantages associated with particular embodiments include providing the ability to understand how an organization needs to accurately measure a business process. Particular embodiments provide an analysis that assists an organization in determining the measurements to take with respect to a business process. For example, embodiments of the present disclosure may facilitate determining whether an organization is performing any measurements at all and what tools and techniques the organization is using. Questions and responses may be tailored to understand how effectively a measurement system is functioning. Particular embodiments may facilitate an evaluation of whether an organization is measuring the right criteria with respect to a business process at all, or calculating whether the measurements that are being obtained are being utilized as the organization would like. Particular embodiments may enable an organization to determine whether a routine and structure exist to obtain a predictable outcome with respect to a business process on which to make decisions. Some embodiments may also enable an organization to determine a sense of how well or poorly a business process is performing. For example, particular embodiments may determine whether the organization knows what wait times in call queues should be, instead of determining what the actual wait times are. In some embodiments, each question posed to an interviewee facilitates determining whether a management system exists and how successful the system is according to different dimensions of what a measurement system should measure.

Particular embodiments may determine, from a measurement perspective, the type of needs of an executive of an organization and the adequacy of the business results achieved. Additionally, some embodiments may facilitate the determination that, if the results across all dimensions are positive, the organization likely has measurement system supporting a highly functioning business. Particular embodiments of the present disclosure provide a way of measuring the effectiveness of a measurement system without being confined by the specific details that may be involved in any single dimension, and enables an operator to focus on particular problem areas. Particular embodiments may facilitate the determination of how an organization needs to address a revealed problem.

As a result, particular embodiments of the present disclosure may provide numerous technical advantages. Nonetheless, particular embodiments may provide some, none, or all of these technical advantages, and may provide additional technical advantages.

### BRIEF DESCRIPTION OF THE DRAWINGS

A more complete understanding of embodiments of the present disclosure will be apparent from the detailed description taken in conjunction with the accompanying drawings in which:

FIG. 1 illustrates components of an measurement assessment system according to a particular embodiment;

FIG. 2 illustrates an assessment server of FIG. 1 in more detail, in accordance with particular embodiments of the present disclosure;

FIG. 3 is a flow chart illustrating a particular operation of the measurement assessment system of FIG. 1, in accordance with particular embodiments of the present disclosure; and

FIG. 4 illustrates a radar chart showing the results of an analysis performed by the measurement assessment system of FIG. 1, in accordance with particular embodiments of the present disclosure.

### DETAILED DESCRIPTION OF THE INVENTION

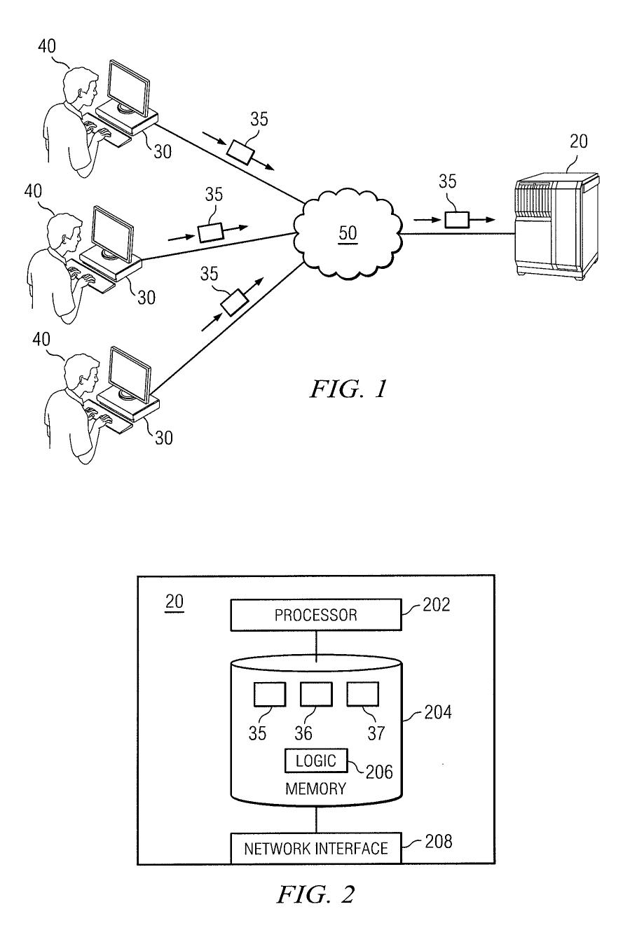

Various embodiments and their advantages may be understood by referring to FIGS. 1-4 of the drawings. FIG. 1 illustrates a measurement assessment system 10 in accordance with particular embodiments of the present disclosure. As shown in FIG. 1, system 10 includes assessment server 20, clients 30, interviewees 40, and network 50. Measurement assessment system 10 diagnoses the current state of an organization's measurement system and presents assessment results and improvement opportunities in an easily understood format. In particular embodiments, system 10 receives input from interviewees 40 regarding the current state of a measurement system associated with a particular business process. Input may be received from interviewees 40 in response to questions or prompts posed by an interviewer and/or clients 30. Based on input received from interviewees 40, assessment server 20 performs an analysis of a measurement system associated with a business process and/or organization.

In some embodiments, system 10 evaluates, based on input received from interviewees 40 and/or clients 30, the current state of a measurement system on seven dimensions. The seven dimensions are Hoshin, Process, Data, Metrics, Scorecard, Technology, and Analytics.

Hoshin represents a business process or goal associated with an organization. Hoshin may signify setting direction and alignment of resources to long-range goals. It is the strategic planning process for an organization. In some embodiments, it is partnered with Kanri, the management process that provides regular performance reviews and the Management by Fact problem solving process. Hoshin may represent a way to ensure that everyone in an organization is working toward the same strategic goal.

Process represents a series of activities that use resources to transform inputs into a desired result or outputs. In some embodiments, Process represents the type of activity used to accomplish the Hoshin.

Data represents factual information associated with Process. In some embodiments, Data represents records of observations or events such as test scores, response times, quality control data, and/or other measurements of the activity represented by Process. Metrics represents a set of parameters measured to demonstrate the status of accomplishing a particular objective. In some embodiments, Metrics represents a quality control fraction necessary to perform at a predefined level. For example, if an organization desires a particular process to perform at a six-sigma level, Metrics represents the rate at which the Process would have to perform to achieve six sigmas of success.

Scorecard represents a device or mechanism used to present an organization's performance metrics. Technology represents any software, hardware, and/or documents used in the gathering, aggregation, analysis, and/or reporting of Data and Metrics. For example, Technology may represent spreadsheet software, word processing software, database software, collaboration software, and/or Hoshin Portal software. Analytics represents a process used to produce an analysis for management and/or officers of an organization in the decision-making process, usually involving trend, drill-down and demographic analysis, and/or profiling.

As an example, Hoshin may represent the desired outcomes of the business process of processing checks received by a financial institution. A particular organization, or portion of organization, may be tasked with processing checks in an efficient and low-error manner. Process, in this example, represents putting checks into a check-processing machine and scanning the checks in order to pay, deposit, and/or cash the amounts indicated on the checks. In this example, Data may represent factual information associated with check processing, such as the total number of checks processed in a given amount of time, and the number of checks that failed and had to be re-processed and/or inputted manually. Metrics, in this example, represents a quantifier necessary to achieve a predefined goal associated with the Hoshin. For example, if an organization's goal is to process checks at a six-sigma level (i.e., at a 99.99966% success rate), Metrics represents a fraction of checks processed successfully to achieve a 99.99966% success rate. Scorecard represents all metrics put together and provides an analysis of whether an organization is able to display all relevant Metric information in a way that makes sense and demonstrates that the desired business outcomes are being achieved. Scorecard may also additionally or alternately provide an analysis of whether an organization is able to capture information in real time or frequently enough to enable executives in the organization to respond to data and make decisions. In this example, a Scorecard analysis may determine whether an organization is able to capture information related to the number of checks successfully processed. Analytics provides an analysis of whether an organization can determine trends or higher-level information from raw data. In this example, Analytics may determine whether statistical tools are used to look for patterns in the data and determine, based on data, whether a check processing machine needs to be replaced. Analytics may determine, at a high level, whether an organization needs to apply more sophisticated tools to the data. Assessment server 20 may provide an analysis for each of these dimensions in order to provide an assessment of an organization's measurement capabilities associated with a particular process.

An interviewee 40 represents a person associated with a particular business process in an organization. In some embodiments, interviewee 40 is a supervisor and/or manager of a business process. For example, in a manufacturing facility, interviewee 40 may represent a manager of a particular sub-assembly operation, and/or a manager of the entire operation. Interviewee 40 has knowledge of operations and measurements associated with a business process, and responds to questions posed by an interviewer and/or client 30.

Client 30 (each of which may be referred to individually as “client 30” or collectively as “clients 30”) receives input from interviewees 40 in response to questions posed by an interviewer and/or client 30. In some embodiments, client 30 displays one or more questions to interviewee 40 and receives input from interviewee 40 in response to the one or more questions. In particular embodiments, client 30 may display one or more answers from which interviewee 40 selects. A numerical value corresponds to each of the answers. As a result, a numerical value may be associated with each question presented by client 30. In some embodiments, the numerical value is a Likert value in a range of 0-5, indicating a relative effectiveness of an associated dimension of a measurement system. In general, however, numerical values received in response to a question may be included in any suitable range of values, depending on the configuration of system 10. As shown below, each question corresponds to a particular dimension that assessment server 20 analyzes. In particular embodiments, clients 30 represent general or special-purpose computers operating software applications capable of performing the above-described operations. For example, clients 30 may include, but are not limited to, laptop computers, desktop computers, portable data assistants (PDAs), and/or portable media players. In some embodiments, client 30 comprises a general-purpose personal computer (PC), a Macintosh, a workstation, a Unix-based computer, a server computer, or any suitable processing device. Additionally, in particular embodiments, client 30 may include one or more processors operable to execute computer logic and/or software encoded on non-transitory tangible media that performs the described functionality. Client 30 may also include one or more computer input devices, such as a keyboard, trackball, or a mouse, and/or one or more Graphical User Interfaces (GUIs), through which a user may interact with the logic executing on the processor of client 30. In general, client 30 includes any appropriate combination of hardware, software, and/or encoded logic suitable to perform the described functionality. Additionally, clients 30 may be connected to or communicate with assessment server 20, directly or indirectly over network 50. Client 30 may transmit the received input in message 35 to assessment server 20 over network 50. Clients 30 may couple to network 50 through a dedicated wired or wireless connection, or may connect to network 50 only as needed to receive, transmit, or otherwise execute applications. Although FIG. 1 illustrates, for purposes of example, a particular number and type of clients 30, alternative embodiments of system 10 may include any appropriate number and type of clients 30, depending on the particular configuration of system 10.

Assessment server 20 analyzes interviewee 40 input to determine the effectiveness of an organization's measurement system. Assessment server 20 may receive message 35 from client 30. Message 35 includes responses received from interviewee 40. Each response may be associated with a particular aspect (i.e., dimension) of a measurement system analyzed by assessment server 20. Assessment server 20, in some embodiments, averages numerical values associated with a particular dimension to calculate an Average Score for the particular dimension of a measurement system. For example, a plurality of questions may be associated with the Process dimension. Assessment server 20 may average each numerical value received in response to a question associated with the Process dimension to calculate an Average Score for the Process dimension. Based on the Average Score for each of the dimensions, assessment server 20 may calculate and display each of the Average Scores in a chart. In some embodiments, assessment server 20 may display an Average Score associated with each of the dimensions on a radar chart.

Assessment server 20 represents any electronic device operable to receive message 35, and determine one or more Average Scores associated with one or more dimensions of an organization's measurement system. In some embodiments, assessment server 20 represents a general-purpose PC, a Macintosh, a workstation, a Unix-based computer, a server computer, and/or any suitable processing device. Although FIG. 1 illustrates, for purposes of example, a single assessment server 20, alternative embodiments of system 10 may include any appropriate number and type of assessment server 20. Additionally or alternatively, in some embodiments, the functions and operations described above may be cooperatively performed by one or more assessment servers 20.

In order to facilitate communication among the various components of system 10, clients 30 and assessment server 20 are communicatively coupled via one or more networks 50. For example, client 30 may communicate message 35 to assessment server 20 via network 50. Network 50 may represent any number and combination of wireline and/or wireless networks suitable for data transmission. Network 50 may, for example, communicate Internet Protocol packets, frame relay frames, asynchronous transfer mode cells, and/or other suitable information between network addresses. Network 50 may include one or more intranets, local area networks, metropolitan area networks, wide area networks, cellular networks, all or a portion of the Internet, and/or any other communication system or systems at one or more locations. Although FIG. 1 illustrates for purposes of example a single network 50, particular embodiments of system 10 may include any appropriate number and type of networks 50 that facilitate communication among one or more various components of system 10.

An example operation in accordance with particular embodiments of system 10 is now described with reference to FIG. 1. In operation, interviewee 40 provides responses to questions posed by an interviewer and/or client 30. In some embodiments, an interviewer asks questions of interviewee 40. Questions may be predetermined and may be asked in a random order. Each question is associated with a particular aspect (i.e., a dimension) of a measurement system in an organization. For example, Process questions relate to process definition, use of control plans, metric identification, and process review routines. Data questions involve data gathering and managing measurement variation. Metrics questions concern benchmarking and sharing metrics. Scorecard questions relate to business decisions and differences between operating and business results. Technology questions relate to drill down/roll-up capability and the ability to graphically portray process performance. Analytics questions involve whether improvement of a measurement is related to achievement of process goals, and whether metrics are leading indicators of change. Hoshin questions concern business partner agreements that metrics drive business value and whether process metrics align to the business strategy. Example questions that may be asked, and their associated dimensions, are illustrated in Table 1 below. Column A includes a question number. Column B includes a dimension associated with the particular question. Column C includes a question posed to interviewee 40. Column D includes a list of answers from which interviewee 40 selects. Column E includes an area in which interviewee 40 and/or an interviewer may record additional comments pertaining to the answer recorded in Column D. Column F includes a numerical value associated with the answer provided in Column D. Column D may include numerical values based on a Likert scale. For example, if interviewee 40 responds “No” to Question 1, client 30 and/or assessment server 20 may assign a numerical value of 3 to the response. If Interviewee 40 responds “Yes” to Question 1, client 30 and/or assessment server 20 may assign a numerical value of 5 to the response.

TABLE 1

| | | | | | F |
|---|---|---|---|---|---|
| | | | | | Calculated |
| A | B | C | D | E | Rating |
| # | Dimension | Question | Answer | Comments | Value |
| 1 | Hoshin | Have the strategies or | Yes | Document what has | 5 |
| | | tactics of your Hoshin | No | changed in the | 3 |
| | | Plan changed between last | Don't Know | Comments Column | 0 |
| | | year and this year? | | | |
| 2 | Process | Do you have process | Yes | Document the | 5 |
| | | flows, maps or other | No | representations they | 3 |
| | | graphic representations of | Don't Know | have in the Comments | 0 |
| | | your processes? | | Column | |
| 3 | Process | If so, if one of the tools | Very Effective | The control plan | 5 |
| | | you use to manage your | Effective | contains a description of | 4 |
| | | process is a Control Plan, | Neither Effective | the inputs to a process | 3 |
| | | how effective is it in | Nor Ineffective | that should be | 2 |
| | | managing your process? | Very Ineffective | monitored or error- | 1 |
| | | | Do Not Use a | proofed for the purpose | 0 |
| | | | Control Plan | of maintaining | |
| | | | | satisfactory output. It | |
| | | | | should be linked to the | |
| | | | | CTQs and FMEA, | |
| | | | | contain roles and | |
| | | | | responsibilities, reaction | |
| | | | | plans and a | |
| | | | | measurement system. | |
| 4 | Process | If so, if another one of the | Very Effective | A reaction plan is the | 5 |
| | | tools you use to manage | Effective | standard operating | 4 |
| | | your process is a Reaction | Neither Effective | procedure (SOP) if | 3 |
| | | Plan, please describe the | Nor Ineffective | something unforeseen | 2 |
| | | effectiveness of your | Very Ineffective | happens and is a | 1 |
| | | reaction plan in | Do Not Use a | component of the | 0 |
| | | responding to out of | Control Plan | control plan. | |
| | | control conditions. | | | |
| 5 | Process | If so, please describe the | Very Effective | Document the frequency | 5 |
| | | effectiveness of your | Effective | of the routines (daily, | 4 |
| | | routines to review, | Neither Effective | weekly, monthly, etc.). | 3 |
| | | validate and/or update | Nor Ineffective | | 2 |
| | | your process and related | Very Ineffective | | 1 |
| | | documentation | Do Not Use a | | 0 |
| | | | Control Plan | | |
| 6 | Process | Please describe the | Very Effective | Probing question - What | 3 |
| | | effectiveness with which | Effective | technique is used to | 4 |
| | | you identify new | Neither Effective | identify improvements | 3 |
| | | measures and process | Nor Ineffective | and new measures? | 2 |
| | | improvements | Very Ineffective | Example - Management | 1 |
| | | | Do Not Use a | By Fact? | 0 |
| | | | Control Plan | | |
| 7 | Data | Please describe the | Very Effective | What factors did you | 5 |
| | | effectiveness of your | Effective | consider in coming to | 4 |
| | | routines to gather data | Neither Effective | this conclusion? These | 3 |
| | | that supports your | Nor Ineffective | routines should be | 2 |
| | | processes and/or goals. | Very Ineffective | documented in a data | 1 |
| | | | Do Not Use a | collection plan. | 0 |
| | | | Control Plan | | |
| 8 | Data | Please describe how | Very Effective | What factors did you | 5 |
| | | effectively you minimize | Effective | think about in coming to | 4 |
| | | variation within the data | Neither Effective | this conclusion? | 3 |
| | | gathering process. | Nor Ineffective | This would be done with | 2 |
| | | | Very Ineffective | a Measurement System | 1 |
| | | | Do Not Use a | Analysis. MSA is an | 0 |
| | | | Control Plan | analytical procedure to | |
| | | | | determine how much of | |
| | | | | the total variation in the | |
| | | | | process you are | |
| | | | | measuring comes from | |
| | | | | its measurement system. | |
| 9 | Analytics | Please describe how | Very Effective | Strength of relationship, | 5 |
| | | effectively movement in | Effective | correlation | 4 |
| | | your metrics is related to | Neither Effective | | 3 |
| | | the achievement of your | Nor Ineffective | | 2 |
| | | process goals. | Very Ineffective | | 1 |
| | | | Do Not Use a | | 0 |
| | | | Control Plan | | |
| 10 | Metrics | Have you benchmarked | Yes | If so, please describe | 5 |
| | | the metrics you use either | No | how you benchmarked | 1 |
| | | internally or eternally? | Don't Know | your metrics. | 0 |
| 11 | Metrics | Are any of your metrics | Yes | Document with whom | 5 |
| | | shared with partners or do | No | the metrics are shared | 1 |
| | | you use commonly | Don't Know | or the source of your | 0 |
| | | defined metrics? | | common definitions. | |
| 12 | Metrics | How effectively do your | Very Effective | No Comment for this | 5 |
| | | metrics tell you whether | Effective | cell | 4 |
| | | your process is stable? | Neither Effective | | 3 |
| | | | Nor Ineffective | | 2 |
| | | | Very Ineffective | | 1 |
| | | | Do Not Use a | | 0 |
| | | | Control Plan | | |
| 13 | Metrics | If you have identified new | Very Effective | No Comment for this | 5 |
| | | metrics recently, how | Effective | cell | 4 |
| | | effective was your base | Neither Effective | | 3 |
| | | lining and target setting | Nor Ineffective | | 2 |
| | | process? | Very Ineffective | | 1 |
| | | | Do Not Use a | | 0 |
| | | | Control Plan | | |
| 14 | Scorecard | How effectively does | Very Effective | What factors did you | 5 |
| | | your scorecard or | Effective | consider? | 4 |
| | | dashboard support the | Neither Effective | Document an example of | 3 |
| | | business decisions you | Nor Ineffective | the types of business | 2 |
| | | need to make? | Very Ineffective | decisions the customer | 1 |
| | | | Do Not Use a | needs to make. | 0 |
| | | | Control Plan | | |
| 15 | Hoshin | Please describe how | Very Effective | What factors did you | 5 |
| | | effectively your process | Effective | consider in evaluating | 4 |
| | | metrics align to the | Neither Effective | this level of | 3 |
| | | business strategy. | Nor Ineffective | effectiveness? | 2 |
| | | | Very Ineffective | | 1 |
| | | | Do Not Use a | | 0 |
| | | | Control Plan | | |
| 16 | Analytics | How effectively does | Very Effective | No Comment for this | 5 |
| | | your scorecard provide | Effective | cell | 4 |
| | | you with a leading | Neither Effective | | 3 |
| | | indication that you are on | Nor Ineffective | | 2 |
| | | track to achieve your | Very Ineffective | | 1 |
| | | goal(s)? | Do Not Use a | | 0 |
| | | | Control Plan | | |
| 17 | Scorecard | What words best describe | Both Happening | It Already Happened - | 5 |
| | | the time period(s) | Now and What | Data is Historical | 4 |
| | | reported by your metrics? | will Happen | Happening Now - Data | 3 |
| | | | Both Happening | is current | 2 |
| | | | Now and it | What will Happen - | 0 |
| | | | Already | Data describe the future | |
| | | | Happened | | |
| | | | Just What is | | |
| | | | Happening Now | | |
| | | | Just What | | |
| | | | Already | | |
| | | | Happened | | |
| | | | Don't Know | | |
| 18 | Technology | How effectively do your | Very Effective | Another way of asking | 5 |
| | | tools or system(s) of | Effective | this question is - does | 4 |
| | | record enable you to drill | Neither Effective | your system of record | 3 |
| | | down to operating | Nor Ineffective | enable an associate to | 2 |
| | | performance and roll up | Very Ineffective | see their contribution | 1 |
| | | to business or financial | Do Not Use a | your business or | 0 |
| | | results? | Control Plan | financial results? | |
| 19 | Hoshin | Please describe the degree | Very Effective | No Comment | 5 |
| | | to which your business | Effective | | 4 |
| | | partners agree that your | Neither Effective | | 3 |
| | | process metrics drive | Nor Ineffective | | 2 |
| | | business value. | Very Ineffective | | 1 |
| | | | Do Not Use a | | 0 |
| | | | Control Plan | | |
| 20 | Technology | How efficiently do your | Very Efficient | What tools are you | 5 |
| | | tools or systems of record | Efficient | using? | 4 |
| | | enable you to graphically | Neither Efficient | Very Efficient - Data | 3 |
| | | portray the performance | Nor Inefficient | and Reporting are | 2 |
| | | of your process? | Inefficient | Integrated with very few | 1 |
| | | | Very Inefficient | manual steps | 0 |
| | | | Don't Know | Efficient - Data and | |
| | | | | Reporting are Integrated | |
| | | | | with some manual steps | |
| | | | | Neither Efficient nor | |
| | | | | Inefficient - Data and | |
| | | | | reporting are not | |
| | | | | integrated and there are | |
| | | | | some manual steps | |
| | | | | Inefficient - Data and | |
| | | | | reporting are not | |
| | | | | integrated and there are | |
| | | | | many manual steps | |
| | | | | Very Inefficient - Data is | |
| | | | | gathered manually and | |
| | | | | there are many manual | |
| | | | | steps for reporting | |

Once interviewee 40 responds to each question, client 30 transmits message 35 to assessment server 20. Message 35 includes the numerical value associated with a response for each question. Assessment server 20 averages each response associated with a particular category. For example, for each question associated with the Hoshin dimension, assessment server 20 averages the numerical values received from interviewee 40. The average numerical value may be stored as an Average Score associated with the Hoshin dimension. Assessment server 20 may store the Average Score for further processing. In some embodiments, client 30 and/or an interviewer poses questions to a plurality of interviewees 40. Client 30 may transmit one or more messages 35 that include responses associated with each interviewee 40 to assessment server 20. As a result, assessment server 20 may receive responses associated with each dimension for a plurality of interviewees 40. Assessment server 20 may average the plurality of responses for each dimension, and determine an Average Score associated with each respective dimension. In this way, assessment server 20 may determine an Average Score based on responses received from one or more interviewees 40.

In some embodiments, assessment server 20 calculates an Improvement Opportunity value based on an average of the Average Scores. In some embodiments, if the average of the Average Scores is less than two (2), assessment server 20 sets the Improvement Opportunity to three (3). The value three (3) reflects the Likert value that generally relates to the verbal evaluation of “Neither Effective nor Ineffective.” Generally the value three (3) is considered to be the minimal level of acceptable performance.

If the average of the average of the Average Scores is greater than four (4), assessment server 40 sets the Improvement Opportunity value for each dimension axis to five (5). The value five (5) reflects the Likert value that generally relates to the verbal evaluation of “Very Effective.” Generally the value five (5) is considered to be the maximum level of performance.

If the average of the Average Scores is neither less than two nor greater than 4, the average of the Average Scores is incremented by one (1) to set the Improvement Opportunity value for each dimension axis. Values between three (3) and five (5) are desirable with values close to five (5) being more desirable.

Once Average Scores are calculated for each dimension, and an Improvement Opportunity value is calculated, assessment server 20 facilitates display of the Improvement Opportunity value on a radar chart, and superimposes the Average Scores over the Improvement Opportunity values on the radar chart. A radar chart has seven axes corresponding to the dimensions of a measurement system. The values of the axes of the radar chart correspond to the Likert values of 0-5. The benefit of the Average Scores being superimposed on the Improvement Opportunity values is that gaps are immediately apparent and this provides context for discussion of priorities and next steps in the evaluation of a measurement system.

In some embodiments, assessment server 20 selects a subset of questions to facilitate a Kanri review process. A Kanri review may include a business review to determine whether an organization is performing according to the business needs. A Kanri review looks at key elements of data, metrics and scorecard to determine the effectiveness of a business process (i.e., is the organization gathering data, turning the data into metrics that are meaningful, and presenting the data in a meaningful way). The Kanri review may determine whether an organization is doing all the things from a measurement perspective to be successful. In particular embodiments, assessment server 20 may select questions 7, 8, 9, 10, 11, 12, 13, 14, and 17 in Table 1 to facilitate a Kanri review process.

Particular embodiments of the present disclosure may provide numerous operational benefits, including providing the ability to understand what an organization needs to do to accurately measure a business process. Particular embodiments provide an analysis of assisting an organization in determining what needs to be measured with respect to a business process. For example, system 10 may facilitate determining whether an organization is doing any measurements at all and what tools and techniques it is using. Questions and responses may be tailored to understand get a sense of how well a measurement system is functioning. Particular embodiments may facilitate an evaluation of whether an organization is measuring the right things with respect to a business process at all, or calculating whether the measurements that are being obtained are doing as the organization would like. Particular embodiments may enable an organization to determine whether it has a routine and structure in place to get a predictable outcome with respect to a business process to make decisions on. Some embodiments may also enable an organization to determine a sense of how well or poorly a business process is performing. For example, particular embodiments may enable a determination of not what wait times in call queue are, but whether the organization has any idea what wait times are. In some embodiments, each question posed to interviewee 40 is geared to determining whether a management system exists and how successful it is according to different aspects of what a measurement system should measure.

Particular embodiments of system 10 gives from a measurement prospective what type of needs an executive of an organization has and also gives business results. System 10 may facilitate the determination that, if the results across all aspects are positive, it is like that the organization is a highly functioning business. In particular embodiments, system 10 provides a way of measuring the effectiveness of a measurement system without getting locked into all of the expertise that may be involved in any single aspect, and enables an operator to focus in on particular problem areas. Particular embodiments may facilitate the determination of what package an organization needs to put together to address a revealed problem. As a result, system 10 may provide numerous operational benefits. Nonetheless, particular embodiments may provide some, none, or all of these operational benefits, and may provide additional operational benefits.

Modifications, additions, or omissions may be made to measurement assessment system 10 without departing from the scope of the present disclosure. For example, when a measurement assessment system 10 determines information, the component may determine the information locally or may receive the information from a remote location. As another example, in the illustrated embodiment, client 30 and assessment server 20 are represented as different components of measurement assessment system 10. However, the functions of client 30 and assessment server 20 may be performed by any suitable combination of one or more servers or other components at one or more locations. In the embodiment where the various components are servers, the servers may be public or private servers, and each server may be a virtual or physical server. The server may include one or more servers at the same or at remote locations. Also, client 30 and assessment server 20 may include any suitable component that functions as a server. Additionally, measurement assessment system 10 may include any appropriate number of clients 30 and/or assessment servers 20. Any suitable logic may perform the functions of measurement assessment system 10 and/or comprise the components within measurement assessment system 10.

FIG. 2 is a block diagram illustrating aspects of assessment server 20 discussed above with respect to FIG. 1. Assessment server receives message 35 that includes numerical values corresponding to input received from interviewee 40. Assessment server 20 calculates an Average Score for each dimension by averaging the numerical values corresponding to each respective dimension. Assessment server 20 further calculates an average of the Average Scores, and determines an Improvement Opportunity value based on the average of the Average Scores. In some embodiments, assessment server 20 displays the Average Scores and the Improvement Opportunity values on a radar chart. Assessment server 20 includes processor 202, memory 204, logic 206, and network interface 208.

Assessment server 20 comprises any suitable combination of hardware and/or software implemented in one or more modules to provide or perform the functions and operations described above with respect to FIG. 1. In some embodiments, assessment server 20 may comprise a mainframe computer, general-purpose, a Macintosh, a workstation, a Unix-based computer, a server computer, or any suitable processing device. In some embodiments, the functions and operations described above may be performed by a pool of multiple assessment servers 20. Assessment server 20 may interact and/or communicate with other computer systems associated with system 10.

Memory 204 comprises any suitable arrangement of random access memory (RAM), read only memory (ROM), magnetic computer disk, CD-ROM, or other magnetic or optical storage media, or any other volatile or non-volatile memory devices that store one or more files, lists, tables, or other arrangements of information, such as message 35, Average Score 36, Improvement Opportunity value 37, and/or input received from interviewee 40. Although FIG. 2 illustrates memory 204 as internal to Assessment server 20, it should be understood that memory 204 may be internal or external to assessment server 20, depending on particular implementations. Memory 204 may be separate from or integral to other memory devices to achieve any suitable arrangement of memory devices for use in system 10.

Memory 204 is further operable to store logic 206. Logic 206 generally comprises rules, algorithms, code, tables, and/or other suitable instructions for receiving, storing, generating, and/or transmitting relevant information to and/or from client 30.

Memory 204 is communicatively coupled to processor 202. Processor 202 is generally operable to execute logic to perform operations described herein. Processor 202 comprises any suitable combination of hardware and software implemented in one or more modules to provide the described functions or operations.

Network interface 208 communicates information with one or more networks 50. For example, network interface 208 may communicate with client 30 over or more networks 50 through network interface 208.

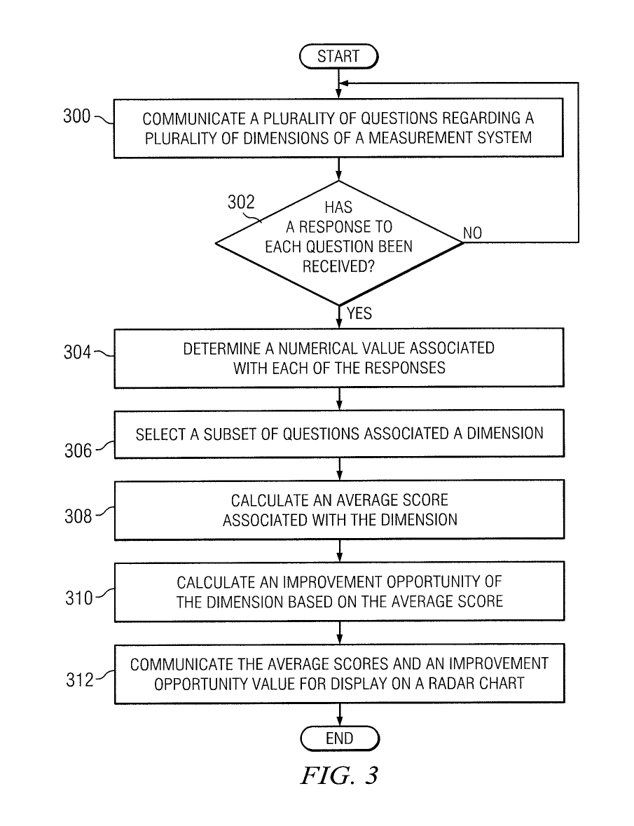

FIG. 3 is a flow diagram illustrating a method for a measurement system analysis tool in accordance with particular embodiments of the present disclosure. Operation, in the illustrated example, begins at step 300, in which a plurality of questions associated with a plurality of dimensions of a measurement system are communicated. In particular embodiments, client 30 communicates questions to interviewee 40 via a display associated with client 30. In some embodiments, a interviewer verbally asks questions of interviewee 40.

At step 302, client 30 and/or assessment server 20 determines whether a response is received to each question communicated in step 300. In some embodiments, a response to each of a plurality of questions is received from interviewee 40, each of the plurality of responses associated with one of a plurality of dimensions of a measurement system. In some embodiments, an interviewer asks questions of interviewee 40. Client 20 may prompt questions to interviewer 40, and interviewer 40 enters responses into client 20. Questions may be predetermined and may be asked in any order. Each question is associated with a particular aspect (i.e., a dimension) of a measurement system in an organization. In some embodiments, client 30 transmits message 35 that includes an interviewee's 40 responses to questions posed by an interviewer and/or client 20 to assessment server 20. If a response to each question is received, operation continues at step 304. If a response is not received to each question, operation proceeds by repeating step 300.

At step 304, a numerical value associated with each of the responses is determined. In particular embodiments, client 30 and/or an interviewer may display one or more answers from which interviewee 40 selects. A numerical value corresponds to each of the respective answers. As a result, a numerical value may be associated with each question presented and/or response received. In some embodiments, the numerical value is a Likert value in a range of 0-5, indicating a relative effectiveness of an associated dimension of a measurement system. In general, however, numerical values received in response to a question may be included in any suitable range of values, depending on the configuration of system 10.

At step 306, a subset of the plurality questions, each of the questions in the subset associated with the same respective dimension of the measurement system, is selected for each of the plurality of dimensions. In particular embodiments, each question is associated with a particular aspect (i.e., dimension) of a measurement system. Assessment server 20 selects a subset of questions that are each associated with the same dimension of a measurement system. As a result, assessment server 20 correlates questions associated with the same dimension of a measurement system together.

At step 308, an Average Score is calculated for each of the plurality of dimensions, each of the average scores comprising an average of the numerical values associated with the questions in the subset. Once assessment server 20 correlates questions associated with the same dimension of a measurement system, assessment server 20 calculates an average score by summing the numerical values associated with each response and dividing the sum by the number of questions in the subset. As a result, for each of the aspects, assessment server 20 calculates an average score, the average score indicating a relative effectiveness of the organization as it pertains to the aspect of the measurement system being analyzed. In some embodiments, assessment server graphs each of the average scores on a radar chart, enabling an operator of system 10 to easily determine where the relative effectiveness or ineffectiveness of each one of the aspects being measured.

At step 310, an Improvement Opportunity value is calculated based on an average of the Average Scores. As discussed above, if the average of the Average Scores is less than two (2), assessment server 20 sets the Improvement Opportunity to three (3). The value three (3) reflects the Likert value that generally relates to the verbal evaluation of “Neither Effective nor Ineffective.” Generally the value three (3) is considered to be the minimal level of acceptable performance. If the average of the average of the Average Scores is greater than four (4), assessment server 40 sets the Improvement Opportunity value for each dimension axis to five (5). The value five (5) reflects the Likert value that generally relates to the verbal evaluation of “Very Effective.” Generally the value five (5) is considered to be the maximum level of performance. If the average of the Average Scores is neither less than two nor greater than 4, the average of the Average Scores is incremented by one (1) to set the Improvement Opportunity value for each dimension axis. Values between three (3) and five (5) are desirable with values close to five (5) being more desirable.

At step 312, the Average Scores and an Improvement Opportunity value are communicated for display on a radar chart. In some embodiments, assessment server 20 may display on a GUI associated with assessment server 20 a radar chart that includes each Average Score associated with a dimension of a measurement system and an Improvement Opportunity value based on an average of the Average Scores. In some embodiments, Average Scores and an Improvement Opportunity value are communicated to client 30 for display in a radar chart on a GUI associated with client 30.

Some of the steps illustrated in FIG. 3 may be combined, modified, or deleted where appropriate, and additional steps may also be added to the flowchart. Additionally, steps may be performed in any suitable order without departing from the scope of the disclosure.

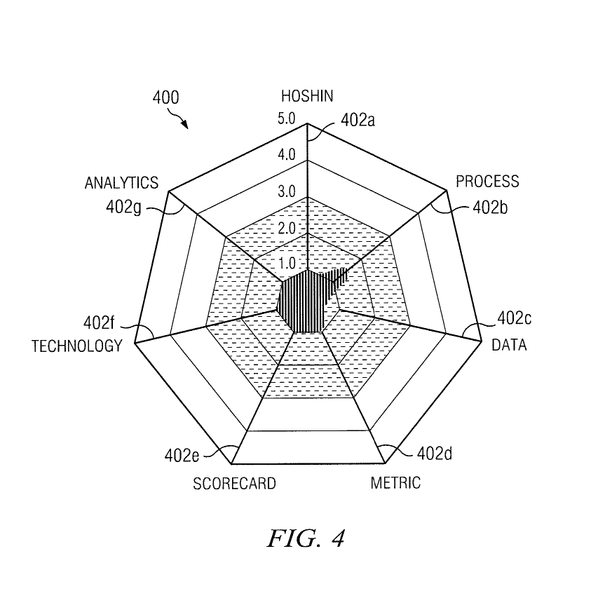

FIG. 4 illustrates an example radar chart 400 utilized in accordance with particular embodiments of the present disclosure. In some embodiments, radar chart 400 displays Average Scores associated with each dimension of a measurement being analyzed. Dimensions 402a-g (i.e., dimensions) are components of a measurement system that may be present in order to report results and enable further decision-making. As shown in FIG. 4, dimensions 402a-g are in clockwise order. As shown in radar chart 400, the maturity of dimensions 402 increases as it moves outward (from 1.0 (highly ineffective) to 5.0 (highly effective). Area A represents the results of an analysis performed by an assessment server 20. The intersection of the perimeter of Area A with each dimension 402 indicates the Average Score associated with each particular dimension. For example, the Average Score associated with Process is 1.5 and the Average Score associated with Data is 0.5 in radar chart 402. Area B represents the improvement opportunity value for each dimension 402. As discussed above, if the average of the Average Scores is less than two (2), an Improvement Opportunity value is set at three (3.0). An area between Area A and Area B indicates an improvement opportunity with respect to each dimension 402. Radar chart 400 may be used to make decisions with respect to improving various dimensions of a measurement system in an organization.

Although the present disclosure has been described in detail with reference to particular embodiments, it should be understood that various other changes, substitutions, and alterations may be made hereto without departing from the spirit and scope of the present disclosure. For example, all of the elements included in particular embodiments of the present disclosure may be combined, rearranged, or positioned in order to accommodate particular manufacturing or operational needs.

What is claimed is:

1. A method comprising:
communicating a plurality of questions associated with a plurality of dimensions of a measurement system;
receiving a response to each of the plurality of questions, each of the plurality of responses associated with one of the plurality of dimensions of the measurement system;
determining, for each of the responses, a numerical value associated with the response;
for each of the plurality of dimensions, selecting a subset of the plurality questions, each of the questions in the subset associated with the same respective dimension of the measurement system; and
calculating, for each of the plurality of dimensions, an average score, wherein each average score comprises an average of the numerical values associated with the questions in the subset.

2. The method of claim 1, further comprising displaying each of the average scores on a radar chart.

3. The method of claim 1, further comprising:
calculating an average of the average scores; and
based on the average of the average scores, determining an improvement opportunity value.

4. The method of claim 3, wherein determining the improvement opportunity value comprises:
if the average of the average scores is less than two, determining that the improvement opportunity value is three;
if the average of the average scores is greater than four, determining that the improvement opportunity value is five; and
if the average of the average of the scores is greater than two and less than four, determining that the improvement opportunity value is equal to the average of the average scores plus one.

5. The method of claim 3, further comprising:
displaying each of the average scores on a radar chart; and
displaying the improvement opportunity value on the radar chart.

6. The method of claim 1, wherein the dimensions of the measurement system include Hoshin, Process, Data, Metrics, Scorecard, Technology, and Analytics.

7. A system comprising:
a processor operable to:
communicate a plurality of questions associated with a plurality of dimensions of a measurement system;
receive a response to each of the plurality of questions, each of the plurality of responses associated with one of a plurality of dimensions of the measurement system;
determine, for each of the responses, a numerical value associated with the response;
for each of the plurality of dimensions, select a subset of the plurality questions, each of the questions in the subset associated with the same respective dimension of the measurement system; and
calculate, for each of the plurality of dimensions, an average score, wherein each average score comprises an average of the numerical values associated with the questions in the subset; and
a memory coupled to the processor operable to store each of the numerical values, the average scores, and the responses.

8. The system of claim 7, wherein the processor is further operable to display each of the average scores on a radar chart.

9. The system of claim 7, wherein the processor is further operable to:
calculate an average of the average scores; and
based on the average of the average scores, determine an improvement opportunity value.

10. The system of claim 9, wherein the processor is operable to determine the improvement opportunity value by:
if the average of the average scores is less than two, determining that the improvement opportunity value is three;
if the average of the average scores is greater than four, determining that the improvement opportunity value is five; and
if the average of the average of the scores is greater than two and less than four, determining that the improvement opportunity value is equal to the average of the average scores plus one.

11. The system of claim 9, wherein the processor is further operable to:
display each of the average scores on a radar chart; and
display the improvement opportunity value on the radar chart.

12. The system of claim 7, wherein the plurality of dimensions of the measurement system include Hoshin, Process, Data, Metrics, Scorecard, Technology, and Analytics.

13. A non-transitory computer readable medium encoded with logic, the logic operable, when executed on a processor, to:
communicate a plurality of questions associated with a plurality of dimensions of a measurement system
receive a response to each of the plurality of questions, each of the plurality of responses and questions associated with one of a plurality of dimensions of a measurement system;
determine, for each of the responses, a numerical value associated with the response;
for each of the plurality of dimensions, select a subset of the plurality questions, each of the questions in the subset associated with the same respective dimension of the measurement system; and
calculate, for each of the plurality of dimensions, an average score, wherein each average score comprises an average of the numerical values associated with the questions in the subset.

14. The non-transitory computer readable medium of claim 13, wherein the logic is further operable to display each of the average scores on a radar chart.

15. The non-transitory computer readable medium of claim 13, wherein the logic is further operable to:
calculate an average of the average scores; and
based on the average of the average scores, determine an improvement opportunity value.

16. The non-transitory computer readable medium of claim 15, wherein the logic is operable to determine the improvement opportunity value by:
if the average of the average scores is less than two, determining that the improvement opportunity value is three;
if the average of the average scores is greater than four, determining that the improvement opportunity value is five; and
if the average of the average of the scores is greater than two and less than four, determining that the improvement opportunity value is equal to the average of the average scores plus one.

17. The non-transitory computer readable medium of claim 15, wherein the logic is further operable to:
display each of the average scores on a radar chart; and
display the improvement opportunity value on the radar chart.

18. The non-transitory computer readable medium of claim 15, wherein the plurality of dimensions of the measurement system include Hoshin, Process, Data, Metrics, Scorecard, Technology, and Analytics.
